(19) United States
(12) Patent Application Publication
(10) Pub. No.: US 2018/0300753 A1
(43) Pub. Date: Oct. 18, 2018

(54) Computer-Automated Schedule Optimization

(71) Applicant: clypd, inc., Somerville, MA (US)

(72) Inventors: Marco A. Montes de Oca, Arlington, MA (US); Jason M. Burke, Chestnut Hill, MA (US); Holly Rae, Scituate, MA (US); Peter Campbell Doe, Ridgewood, NJ (US); Katie McCarthy, Boston, MA (US)

(21) Appl. No.: 15/954,919

(22) Filed: Apr. 17, 2018

Related U.S. Application Data
(60) Provisional application No. 62/486,151, filed on Apr. 17, 2017.

(51) Int. Cl. G06Q 30/02

(52) U.S. Cl. CPC G06Q 30/0249; G06Q 30/0273

(57) ABSTRACT

A computerized system performs automated schedule optimization. In particular, the system solves the problem of determining the range of advertisement placement prices that a seller can select from, while still satisfying all of the constraints on the buyers' orders. The system generates such a range of prices automatically based on a variety of data. As a result, the system helps the seller to maximize the prices of the potential placements that can satisfy a set of orders from buyers.

### BACKGROUND

The television (TV) advertisement marketplace consists of buyers (e.g., TV advertising agencies) and sellers (e.g., TV content producers and distributors). Buyers want to maximize their return on investment by maximizing the number of times their advertisements are watched by their selected target audience, and sellers want to maximize the revenue they obtain by selling advertisement placements. These two goals are in conflict. On one hand, the buyers' budget limits and the selective nature of their orders causes any reasonable campaign schedule generator to select the most cost-effective placements from the point of view of the buyer. On the other hand, such a generated schedule limits the earnings potential for the seller if placement prices remain fixed.

### SUMMARY

A computerized system performs automated schedule optimization. In particular, the system solves the problem of determining the range of advertisement placement prices that a seller can select from, while still satisfying all of the constraints on the buyers' orders. The system generates such a range of prices automatically based on a variety of data. As a result, the system helps the seller to maximize the prices of the potential placements that can satisfy a set of orders from buyers.

For example, one embodiment of the present invention is directed to a method, performed by at least one computer processor executing computer program instructions stored on at least one non-transitory computer-readable medium, where the method includes: (A) identifying an initial ratecard percentage associated with a seller; (B) scaling the initial ratecard percentage up and down to produce a plurality of modified ratecard percentages; (C) selecting, from among the plurality of modified ratecard percentages, a minimum ratecard percentage that satisfies at least one buyer constraint in connection with a plurality of inventory units; and (D) selecting, from among the plurality of modified ratecard percentages, a maximum ratecard percentage that satisfies the at least one buyer constraint in connection with a plurality of inventory units having a plurality of associated rates. The at least one buyer constraint max include a maximum spending constraint. Step (B) may include selecting a first initial scaling factor and scaling the initial ratecard percentage based on the first initial scaling factor. Step (B) may further include selecting the first initial scaling factor to have a value greater than one, such that applying the first initial scaling factor to the initial ratecard percentage results in infeasibility of satisfying the at least one buyer constraint in connection with the plurality of inventory units. The at least one buyer constraint may include a maximum spending constraint, and step (C) may include: (C) (1) scaling the plurality of associated rates based on the first initial scaling factor and the initial ratecard percentage to produce a plurality of scaled rates; (C) (2) calculating a minimum deviation of the plurality of scaled rates from the maximum spending constraint; and (C) (3) selecting the maximum ratecard percentage based on the calculated minimum deviation.

Step (B) may further include selecting a second initial scaling factor and scaling the initial ratecard percentage based on the second initial scaling factor. Step (B) may further include selecting the second initial scaling factor to have a value less than one, such that applying the second initial scaling factor to the initial ratecard percentage results in infeasibility of satisfying the at least one buyer constraint in connection with the plurality of inventory units. The at least one buyer constraint may include a maximum spending constraint, and step (D) may include: (D) (1) scaling the plurality of associated rates based on the first initial scaling factor and the initial ratecard percentage to produce a plurality of scaled rates; (D) (2) calculating a minimum deviation of the plurality of scaled rates from the maximum spending constraint; and (D) (3) selecting the minimum ratecard percentage based on the calculated minimum deviation.

8. The method of claim 1, wherein (C) comprises scaling rates associated with the plurality of inventory units based on the plurality of modified ratecard percentages to produce a plurality of modified rates, and selecting the minimum ratecard percentage based on the plurality of modified rates. Step (D) may include scaling rates associated with the plurality of inventory units based on the plurality of modified ratecard percentages to produce a plurality of modified rates, and selecting the maximum ratecard percentage based on the plurality of modified rates.

Other features and advantages of various aspects and embodiments of the present invention will become apparent from the following description and from the claims.

### BRIEF DESCRIPTION OF THE DRAWINGS

FIG. 1 is a graphical representation of unit cost per mille (CPM) versus number of inventory units according to one embodiment of the present invention.

FIG. 2 is a histogram showing the distribution of unit CPMs in an available inventory and the distribution of unit CPMS in a schedule according to one embodiment of the present invention.

FIG. 3 is a histogram showing the distribution of unit CPMs after a scaling factor of two has been applied according to one embodiment of the present invention.

FIG. 4 is a histogram showing the distribution of unit CPMs after a scaling factor of one half has been applied according to one embodiment of the present invention.

FIG. 5 is a graphical illustration of a buyer's target CPM in alignment with a unit CPM histogram according to one embodiment of the present invention.

FIG. 6 is a graphical illustration of a graphical user interface in which performance measures for a schedule are displayed.

FIG. 7 is a dataflow diagram of a system for automatically identifying a feasible rate range according to one embodiment of the present invention.

FIG. 8 is a flowchart of a method performed by the system of FIG. 7 according to one embodiment of the present invention.

### DETAILED DESCRIPTION

The term “advertisement placement opportunity” (also known as an “advertising opportunity”) refers to a defined opportunity to provide an advertisement to one or more viewers via one or more inventory sources. An individual such opportunity may be referred to herein as an “avail,” a “unit of inventory,” or simply a “unit,” while multiple such opportunities may collectively be referred to as “inventory.”Examples of traditional advertisement placement opportunities includes a quarter-page portion of a particular page in a particular issue of a particular magazine, and a 30-second slot within a particular episode of a particular television program. Traditionally, during the process of selling traditional television advertisements, a television advertisement placement opportunity is expressed to advertising buyers in terms of the time during which the buyer's advertisement will air if the buyer purchases the advertisement placement opportunity. Alternatively, for example, advertisement placement opportunities may be expressed in terms of an audience model representing an audience (e.g., an actual or predicted audience) associated with the advertisement placement opportunity, as described in U.S. patent application Ser. No. 14/663,703, filed on Mar. 20, 2015, entitled, “Audience-Based Television Advertising Transaction Engine,” which is incorporated by reference herein.

The term “inventory source” refers herein to one or more output devices for producing advertisement output to a user, such as a screen for producing visual output and/or a speaker for producing auditory output. An inventory source may use one or more such output devices to produce output as part of delivering an advertisement to the user within an advertisement placement opportunity. Examples of inventory sources include televisions, desktop computers, laptop computers, tablet computers, smartphones, and wearable computers. As used herein, the term “impression” refers to a single exposure of a single person or home exposed to a single advertisement.

Consider a television program distributed by a television advertisement seller (e.g., television content producer and distributor). Dispersed within this television program are one or more advertisement placement opportunities, e.g., commercial breaks, that can be sold to television advertisement buyers. This set of advertisement placement opportunities is an example of the seller's “inventory,” as that term is used herein. In conventional systems, the seller typically prices its inventory at the individual unit level. For example, if the inventory associated with the television program consists of three advertisement placement opportunities, then each of these three advertisement placement opportunities is a “unit” of inventory, and the seller typically assigns a price (or range of prices) to each of these three advertisement placement opportunities. The three prices may be the same as, or different from, each other.

When the television program airs, the content (e.g., advertisement) within each such unit of inventory will actually be watched by a certain number of people. Even if it is not feasible to measure the actual number of viewers who watch an individual unit of content (e.g., before the unit of content is aired), the number of people who watch the content within each such unit of inventory may be predicted or estimated in a variety of ways.

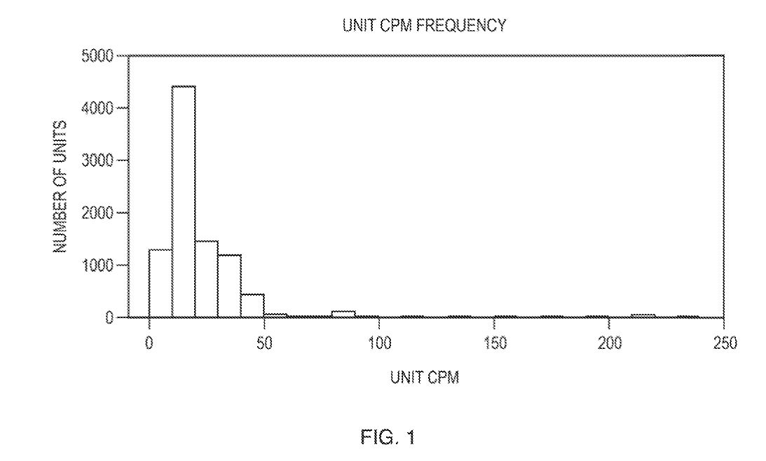

A useful measure in the description that follows is Cost Per Mille (CPM), which represents the cost of purchasing a unit of inventory per thousand people who are exposed to that unit of inventory. The “unit CPM” for a particular unit of inventory may be defined as 1000*(Price of the unit)/(Number of people exposed to the unit). A useful graphical representation of the price distribution in a given inventory is given by the histogram of units at different unit CPM levels as shown in FIG. 1.

The entire set of people who are exposed to a particular advertisement within a particular unit of inventory is referred to herein as the “exposed audience.” The chart shown in FIG. 1 may be constructed to represent the exposed audience. The exposed audience may, however, be segmented into a plurality of subsets referred to herein as “targets” (e.g., classical music lovers, sausage eaters, movie goers). The chart shown in FIG. 1 may be constructed to represent a specific target within the exposed audience.

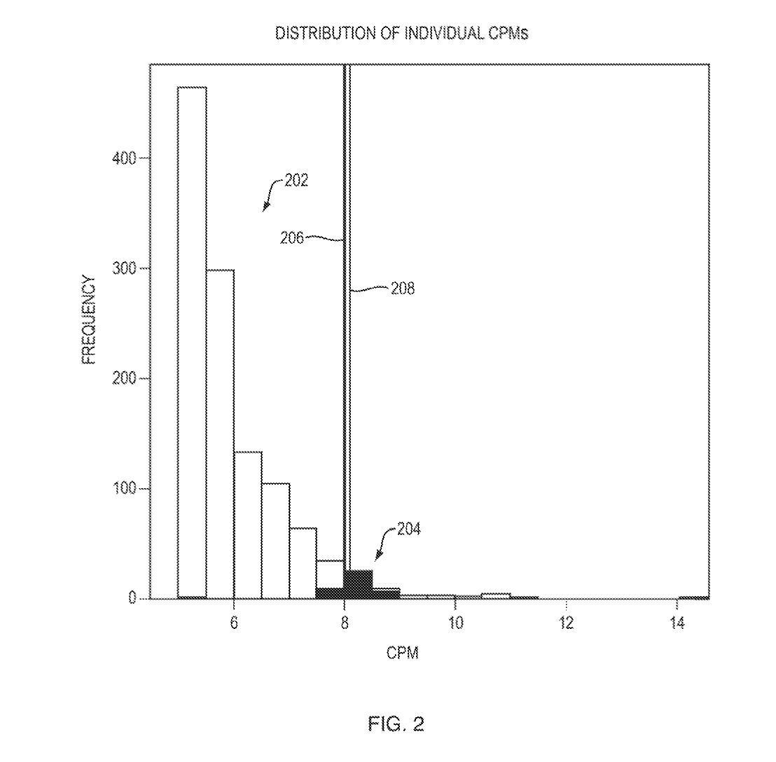

Any particular television advertising campaign, associated with a particular buyer, may include one or more parameters, each of which may have an associated value or range of values. Such parameters typically include at least a target CPM constraint. For example, the buyer might have a $100,000 budget and desire to spend at a rate of $12.50 CPM for the entire exposed audience. Such a constraint corresponds to a total of 8,000,000 impressions of the target audience. Any television advertising campaign schedule generator, therefore, when provided with such a constraint, attempts to buy units from the available inventory so that the average unit CPM of the selected units (defined as 1000*(sum of dollars spent)/(sum of impressions)) is as close to the campaign's target CPM as possible. It is worth noting that the mathematical properties of the TV advertisement scheduling problem are such that it not practical for a person to attempt to solve any instance of it without the use of specialized software and/or hardware. This is shown graphically in FIG. 2.

In FIG. 2, the blue histogram 202 depicts the distribution of the unit CPMs in the available inventory. The superimposed histogram 204 shows the distribution of unit CPMs in the schedule that was produced by a schedule generator as the result of applying the buyer's target CPM constraint to the available inventory. In other words, the histogram 204 represents the units of inventory that were selected by the schedule generator in an attempt to satisfy the buyer's target CPM constraint. The leftmost vertical line 206 represents the buyer's target CPM. The rightmost vertical line 208 represents the average CPM of the scheduled (selected) units.

In the example of FIG. 2, the buyer's target CPM 206 is well-embedded within the unit CPM distribution of the available inventory 202. We can see from FIG. 2 how the selected units of inventory have an average CPM 208 that is relatively close to the buyer's target CPM 206. In situations such as the one illustrated in FIG. 2, the schedule generator attempts to, and usually is capable of (depending on the buyer's other constraints), return a schedule with an average CPM 208 that is very close to the buyer's target CPM 206, resulting in no significant underspending or overspending by the buyer, and with no under/over-delivery of impressions.

A “ratecard percentage” is a percentage by which all of the unit prices in an inventory may be scaled (multiplied). Sellers often apply a ratecard percentage to some or all of the units in a particular inventory to increase (i.e., apply a premium) or decrease (i.e., apply a discount) the prices of those units. For example, a seller might apply a ratecard percentage that is greater than 100% to particularly valuable units, such as units delivered during prime time. As another example, a seller might apply a ratecard percentage that is less than 100% to units that are sold to a buyer who purchases a large number of such units, in order to provide a volume discount to that buyer.

The process of pricing exploration disclosed herein in connection with embodiments of the present invention effectively scales the ratecard percentages up and/or down in an attempt to: (1) discover the minimum and maximum possible rates that are achievable, meaning the minimum and maximum possible rates which allow the buyer's specified constraints (e.g., maximum spending constraint) to be satisfied; and (2) enable the seller to explore the qualitative nature of the advertising schedules that are produced within the feasible rate range, given a particular set of buyer constraints. The term “feasible rate range” refers to the range of rates (e.g., unit CPM rates) that can be produced, given a particular set of buyer constraints, based on the premise that it is mathematically possible to satisfy the buyer's constraints given the available inventory. If it is not possible to satisfy the buyer's constraints given the available inventory, then the buyer's constraints are considered to be “infeasible.”

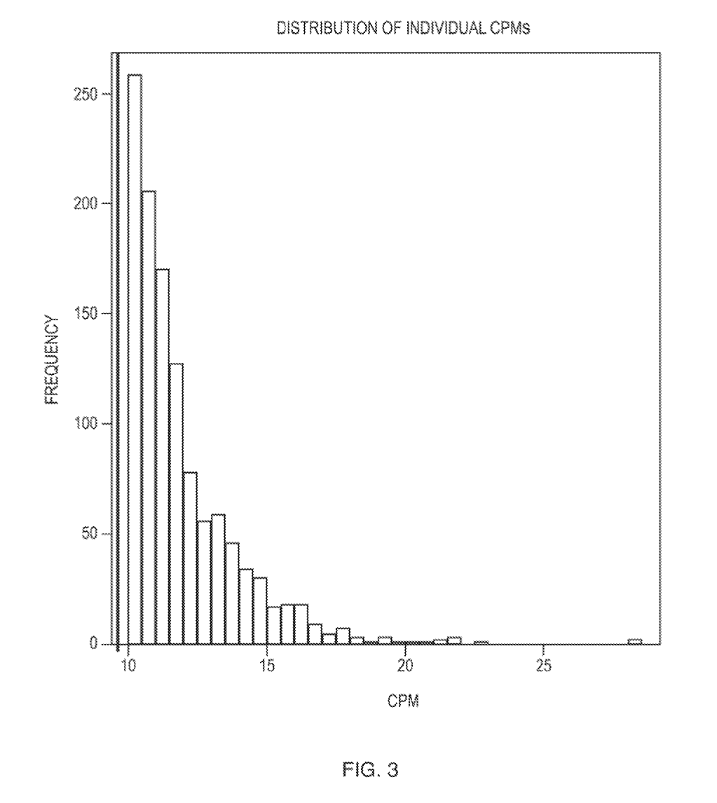

As the rates within a particular inventory are scaled up and/or down, the inventory CPM distribution changes. The net effect of such changes on inventory CPM distribution depends on whether the scaling factor(s) applied to the inventory rates are greater than one or less than one (i.e., 100%). A chart illustrating an example in which a premium of 100% (i.e., a scaling factor of 2) is applied is shown in FIG. 3. In this example, the scaling factor of 100% has been applied to all of the rates (i.e., unit CPM prices) in the inventory of FIG. 2 by multiplying those rates by 2 (i.e., increasing them by the scaling factor of 100%). As shown in FIG. 3, the original buyer's target CPM of $8 is less than the minimum CPM of the inventory that results from scaling the rates in the inventory of FIG. 2 by the 100% scaling factor. In a case such as this, the scheduler may satisfy the buyer's impression requirements, but overspends (i.e., spends more to satisfy the buyer's impression requirements than the buyer desired to spend, as indicated by the buyer's target CPM).

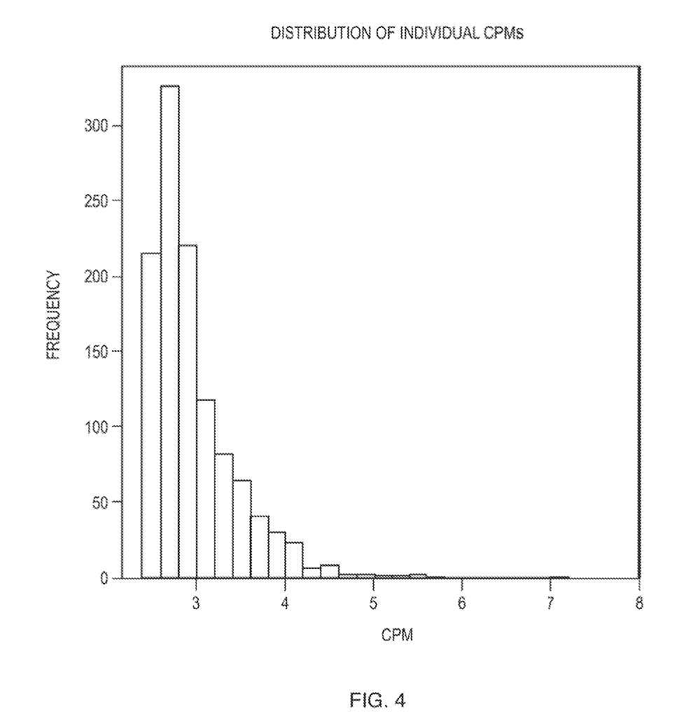

Now consider the chart in FIG. 4, which represents an example in which a discount of 50% (i.e., a scaling factor of 0.5) is applied. In this example, the scaling factor of 50% has been applied to all of the rates (i.e., unit CPM prices) in the inventory of FIG. 2 by multiplying those rates by (i.e., decreasing them by the ratecard percentage of 50%). In this example, the original target CPM of $8 is greater than the maximum CPM of the inventory that results from scaling the rates in the inventory of FIG. 2 by the 50% scaling factor. In a case such as this, the scheduler may satisfy the buyer's impression requirements, but underspends (i.e., spends less to satisfy the buyer's impression requirements than the buyer desired to spend, as indicated by the buyer's target CPM).

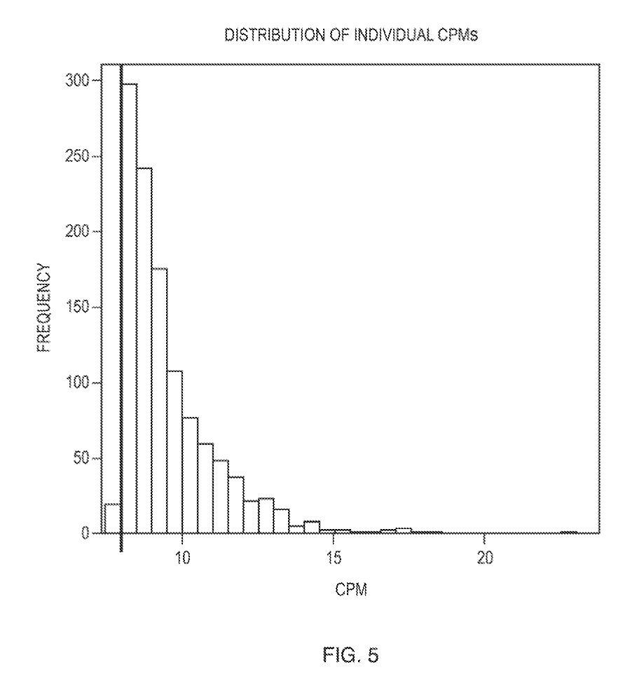

As the examples in FIGS. 3 and 4 illustrate, the effect of applying a premium (i.e., scaling factor greater than 1) or a discount (i.e., scaling factor less than 1) to the inventory unit CPM distribution is to contract or elongate at least part of the inventory unit CPM distribution, respectively. The minimum discount, that is, the minimum discount that the seller may apply while still satisfying the buyer's impression requirements, such that any lower discount would result either in underspending or not satisfying the buyer's impression requirements, is therefore one that results in “aligning” the left side of the inventory unit CPM distribution with the buyer's target CPM line as much as possible. The term “alignment,” as used herein, includes, but is not limited to an exact alignment (i.e., equality). An “alignment,” as that term is used herein, may, for example, include a situation in which the left side of the inventory unit CPM distribution is substantially similar to the buyer's target CPM line, even if the two are not equal to each other. Alignment may, for example, occur when a scaling factor results in: (1) the bulk (e.g., at least x%) of the unit CPM histogram's area being to the right (i.e., greater than) the buyer's target CPM line; and (2) allowing the scheduler to produce a feasible schedule. An example of such alignment is shown in the chart of FIG. 5, in which most of the unit CPM histogram is to the right of the buyer's CPM line (in red).

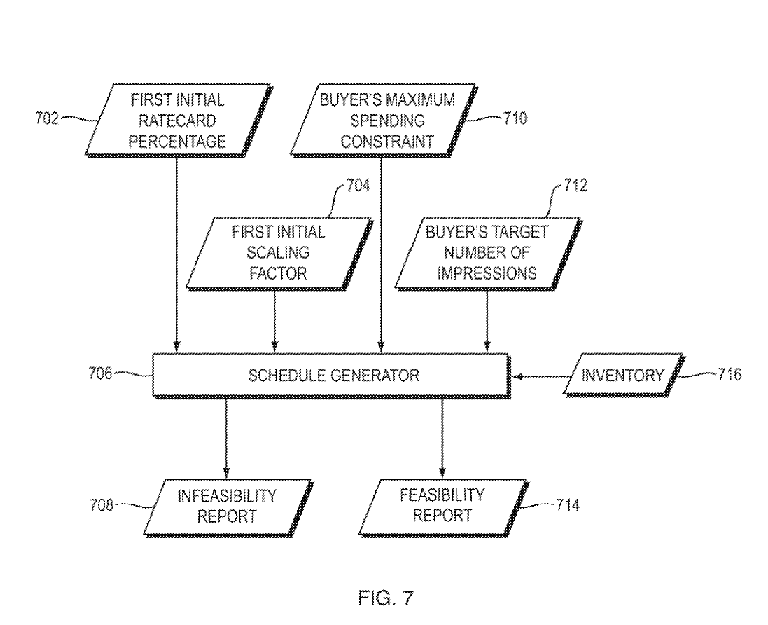

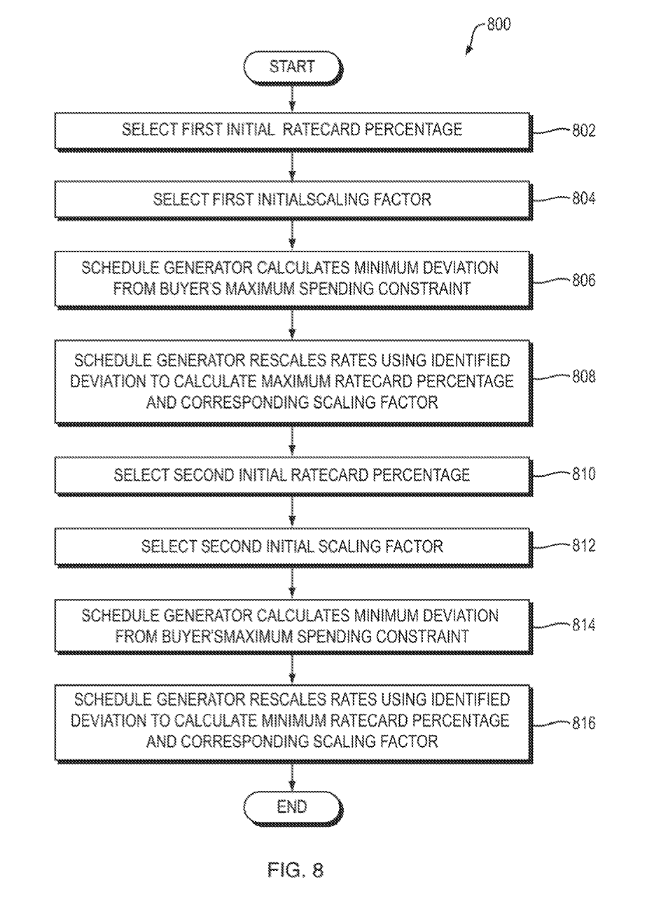

As described generally above, embodiments of the present invention may vary the scaling factor up and/or down in order to identify a minimum discount, as illustrated by the system 700 of FIG. 7 and the method 800 of FIG. 8. The system 700 and method 800 are applied to a particular inventory 716, such as the inventory illustrated in FIG. 2. More generally, the inventory 716 may be any inventory, containing any number of inventory units (avails), each of which may have any unit price.

The system 700 and method 800 are applied to a particular advertising campaign of a buyer. That advertising campaign has a particular set of constraints. Such constraints may include any one or more constraints; embodiments of the present invention are not limited to use in connection with campaigns having any particular constraints. In the particular example illustrated in FIGS. 7 and 8, however, the buyer's advertising campaign includes at least a maximum spending constraint 710 (i.e., the maximum amount that the buyer desires to spend on all impressions, in aggregate, in the schedule that is produced by the system 700 and method 800) and a target number of impressions 712. As described above, any of the constraints in the buyer's advertising campaign, such as the maximum spending constraint 710 and the target number of impressions 712, may be associated with one or more corresponding values. Furthermore, the buyer may provide additional constraints not shown in FIG. 7, such as indicating a desire to spend a particular percentage of its budget (i.e., maximum spending constraint 710) on advertisements placed on a particular network (e.g., CNN), or a desire to spend a particular percentage of its budget during a particular time (e.g., primetime).

The system 700 and method 800 may scale the initial prices associated with the inventory 716 in any of a variety of ways. For example, one embodiment of the present invention uses the following process to identify the minimum and maximum discounts to apply to the prices of the inventory 716:
(1) A first initial ratecard percentage 702 (FIG. 8, operation 802) and a first initial scaling factor 704 are selected (FIG. 8, operation 804). The first initial scaling factor 704 may be selected in any of a variety of ways, such as by selecting a value greater than one for the initial scaling factor 704 which, when multiplied by the first initial ratecard percentage 702, and the resulting product is applied to (e.g., multiplied by) the unit prices of all of the units in the inventory 716, the result is infeasibility. When applied to a histogram such as that shown in FIG. 3, this application of the first initial scaling factor 704 and first initial ratecard percentage 702 in this way results in shifting the inventory unit CPM to the right of the buyer's target CPM.
(2) Running a schedule generator 706 to calculate the minimum deviation of prices of units in the inventory 716 from the maximum spending constraint 710 of the buyer when the first initial ratecard percentage 702 and the first initial scaling factor 704 are applied to the inventory 716 in the manner described above, and outputting an infeasibility report 708 containing the calculated minimum deviation (FIG. 8, operation 806). The schedule generator 706 receives as input the first initial ratecard percentage 702, the first initial scaling factor 704, the buyer's campaign constraints (e.g., the maximum spending constraint 710 and the buyer's target number of impressions 712), and calculates the minimum deviation based on these inputs. For example, if after scaling the rates (i.e., unit prices) of all of the units in the inventory 716 by the product of the first initial ratecard percentage 702 and the first initial scaling factor 704, the least expensive placement (i.e., an ad insertion into a purchased unit of inventory) that satisfies the target number of impressions 712 is $10 and the campaign's maximum spending constraint 710 is $8, then the minimum deviation from the maximum spending constraint 710 is +$2. The schedule generator 706 may use the identified deviation to rescale all of the rates (i.e., unit prices) in the inventory 716 again by an amount that results in the orders (i.e., placements) being barely feasible (i.e., feasible with the smallest possible deviation from infeasibility), and output a feasibility report 714 containing such rates (FIG. 8, operation 808). This results in a maximum ratecard percentage that can be used to produce a feasible schedule, and a corresponding scaling factor (the “maximum scaling factor”). The schedule generator may output both the maximum ratecard percentage and the corresponding scaling factor and include them, for example, in the feasibility report 714.
(3) The schedule generator 706 may apply the same process as that described above, but in the opposite direction, to calculate a minimum ratecard percentage that can be used to produce a feasible schedule, and a corresponding scaling factor (the “minimum scaling factor”).

More specifically, to calculate the minimum ratecard percentage that can be used to produce a feasible schedule, the schedule generator 706 may perform the following steps:
(1) A second initial ratecard percentage (FIG. 8, operation 810) and a second initial scaling factor are selected (FIG. 8, operation 812). Although not shown in FIG. 7, the second initial ratecard percentage and the second initial scaling factor may operate in a manner that is similar to the first initial ratecard percentage 702 and the first initial scaling factor 704 that are shown in FIG. 7. The second initial scaling factor, however, may be selected by selecting a value less than one which, when multiplied by the second initial ratecard percentage, and the resulting product is applied to (e.g., multiplied by) the unit prices of all of the units in the inventory 716, the result is infeasibility. When applied to a histogram such as that shown in FIG. 3, this application of the second initial scaling factor and second initial ratecard percentage 702 in this way results in shifting the inventory unit CPM to the left of the buyer's target CPM.
(2) The schedule generator 706 calculates the minimum deviation of the prices of units in the inventory 716 from the maximum spending constraint 710 of the buyer when the second initial ratecard percentage and the second initial scaling factor 704 are applied to the inventory 716 in the manner described above, and outputs a second infeasibility report (not shown) which, like the first infeasibility report 708 shown in FIG. 7, contains the calculated minimum deviation (FIG. 8, operation 814). The schedule generator 706 receives as input the second initial ratecard percentage, the second initial scaling factor, the buyer's campaign constraints (e.g., the maximum spending constraint 710 and the buyer's target number of impressions 712), and calculates the minimum deviation based on these inputs. The schedule generator 706 may use the identified deviation to rescale all of the rates (i.e., unit prices) in the inventory 716 again by an amount that results in the orders (i.e., placements) being barely feasible (i.e., feasible with the smallest possible deviation from infeasibility), and output a second feasibility report containing such rates (FIG. 8, operation 816). This results in a minimum ratecard percentage that can be used to produce a feasible schedule, and a corresponding scaling factor (the “minimum scaling factor”). The schedule generator may output both the minimum ratecard percentage and the corresponding scaling factor and include them, for example, in the second feasibility report.

To summarize the process described above, to obtain the maximum ratecard percentage and corresponding scaling factor, the schedule generator 706 uses an initially large scaling factor to increase the rates associated with the available inventory 716 by a large amount that results in infeasibility, and then decreases those rates (by decreasing the scaling factor) such that applying that scaling factor to the rates stops producing infeasible schedules (see FIG. 3); conversely, to obtain the minimum ratecard percentage and corresponding scaling factor, the schedule generator 706 uses an initially small scaling factor to reduce the rates associated with the available inventory 716 by a large amount that results in infeasibility, and then increases those rates (by increasing the scaling factor) until applying that scaling factor to the rates stops producing infeasible schedules (see FIG. 4).

The minimum scaling factor, when applied to the unit CPM distribution, produces the largest possible discount while still achieving feasibility. Conversely, the maximum scaling factor, when applied to the unit CPM distribution, produces the largest possible premium while still achieving feasibility. Once the maximum and minimum scaling factors have been produced using the process described above, the schedule generator 706 may produce schedules at any intermediate ratecard percentage by scheduling the unit CPM distribution using a factor that is greater than or equal to the minimum scaling factor and less than or equal to the maximum scaling factor. The process disclosed herein guarantees that any schedules produced using any scaling factor within this range are feasible.

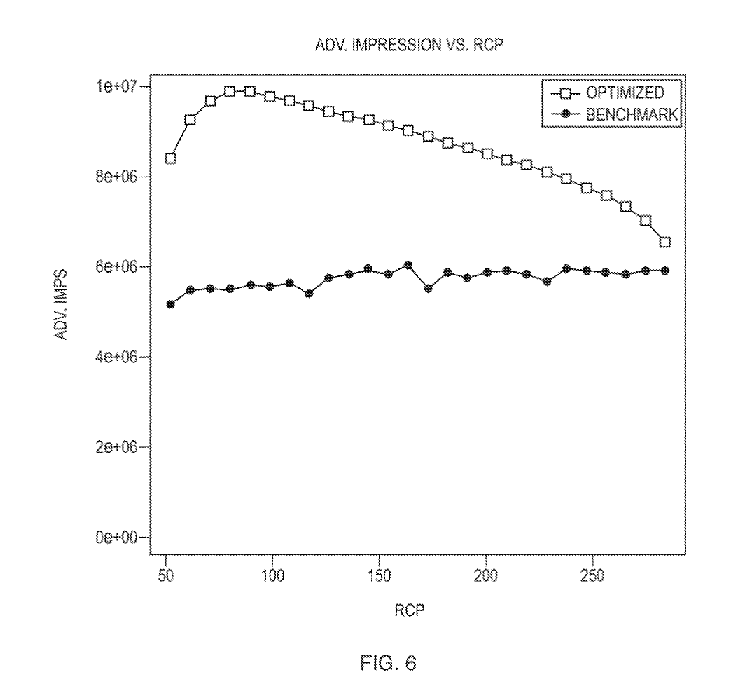

Embodiments of the present invention may automatically generate a number X of schedules within the minimum and maximum ratecard percentages (i.e., using scaling factors that are greater than or equal to the minimum scaling factor and less than or equal to the maximum scaling factor), where X may be any number. The set of X scaling factors within this range may be selected in any way, such as by evenly spacing them within the range. Output representing the resulting schedules may be generated and provided to the user. Furthermore, a graph representing performance measures may be generated and displayed to the user, as in the example shown in FIG. 6.

Such a graphical depiction of the number of advanced target impressions (shown as “Adv. Imps” in FIG. 6) versus the ratecard percentage (shown as “rcp” in FIG. 6) allows the user to easily understand the conflicting nature of the buyer's goals (i.e., maximizing advertising target impressions) and the seller's goals (i.e., maximizing ratecard percentage). By presenting the user with graphs such as the one shown in FIG. 6, the user can make an informed decision regarding which ratecard percentage, and therefore which price, is most efficient for the particular deal in question.

Sometimes, as in the example in FIG. 6, the interval between the minimum and maximum ratecard percentages is too large, and therefore the qualitative difference between the schedules associated with two adjacent points in the type of graph shown in FIG. 6 may be very large. To address this problem, the graph of FIG. 6 may be implemented using a user interface which enables the user to select two points on one of the curves in the graph and to provide an instruction to generate a predefined number of proposed schedules, in response to which embodiments of the present invention may generate the predefined number of proposed schedules within the range of ratecard percentages selected by the user. In effect, such a user interface acts like a “zoom in” tool that allows the user to explore a smaller pricing region in more detail than is possible with the initial, large, range of ratecard percentages that is used to generate the graph of FIG. 6.

One advantage of embodiments of the present invention is that they solve the problem of determining the range of advertisement placement prices that a seller can select from, while still satisfying all of the constraints on the buyers' orders. The system generates such a range of prices automatically based on a variety of data. As a result, the systems helps the seller to maximize the prices of the potential placements that can satisfy a set of orders from buyers.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention automatically apply a variety of scaling factors to a unit CPM distribution using a multi-step process that would be impossible or impractical to implement mentally and/or manually. More generally, the problem of scheduling television advertisements belongs to a class of problems known to be computationally hard (see, e.g., “The complexity of scheduling TV commercials,” Electronic Notes in Theoretical Computer Science, Vol. 40, pages 162-185 (2001), Klemens Hagele and Colm Dunlaing and Soren Riis. A human, therefore, would find it overwhelming and, as a practical matter, impossible to schedule television advertisements within the applicable temporal and other constraints.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor executing computer program instructions stored on at least one non-transitory computer-readable medium, the method comprising:
(A) identifying an initial ratecard percentage associated with a seller;
(B) scaling the initial ratecard percentage up and down to produce a plurality of modified ratecard percentages;
(C) selecting, from among the plurality of modified ratecard percentages, a minimum ratecard percentage that satisfies at least one buyer constraint in connection with a plurality of inventory units; and
(D) selecting, from among the plurality of modified ratecard percentages, a maximum ratecard percentage that satisfies the at least one buyer constraint in connection with a plurality of inventory units having a plurality of associated rates.

2. The method of claim 1, wherein (B) comprises selecting a first initial scaling factor and scaling the initial ratecard percentage based on the first initial scaling factor.

3. The method of claim 2, wherein (B) further comprises selecting the first initial scaling factor to have a value greater than one, such that applying the first initial scaling factor to the initial ratecard percentage results in infeasibility of satisfying the at least one buyer constraint in connection with the plurality of inventory units.

4. The method of claim 3, wherein the at least one buyer constraint comprises a maximum spending constraint, and wherein (C) comprises:
(C) (1) scaling the plurality of associated rates based on the first initial scaling factor and the initial ratecard percentage to produce a plurality of scaled rates;
(C) (2) calculating a minimum deviation of the plurality of scaled rates from the maximum spending constraint; and
(C) (3) selecting the maximum ratecard percentage based on the calculated minimum deviation.

5. The method of claim 3, wherein (B) further comprises selecting a second initial scaling factor and scaling the initial ratecard percentage based on the second initial scaling factor.

6. The method of claim 5, wherein (B) further comprises selecting the second initial scaling factor to have a value less than one, such that applying the second initial scaling factor to the initial ratecard percentage results in infeasibility of satisfying the at least one buyer constraint in connection with the plurality of inventory units.

7. The method of claim 6, wherein the at least one buyer constraint comprises a maximum spending constraint, and wherein (D) comprises:
(D) (1) scaling the plurality of associated rates based on the first initial scaling factor and the initial ratecard percentage to produce a plurality of scaled rates;
(D) (2) calculating a minimum deviation of the plurality of scaled rates from the maximum spending constraint; and
(D) (3) selecting the minimum ratecard percentage based on the calculated minimum deviation.

8. The method of claim 1, wherein (C) comprises scaling rates associated with the plurality of inventory units based on the plurality of modified ratecard percentages to produce a plurality of modified rates, and selecting the minimum ratecard percentage based on the plurality of modified rates.

9. The method of claim 8, wherein (D) comprises scaling rates associated with the plurality of inventory units based on the plurality of modified ratecard percentages to produce a plurality of modified rates, and selecting the maximum ratecard percentage based on the plurality of modified rates.

10. The method of claim 1, wherein the at least one buyer constraint comprises a maximum spending constraint.

11. A system comprising at least one non-transitory computer-readable medium having computer program instructions stored thereon, wherein the computer program instructions are executable by at least one computer processor to perform a method, the method comprising:
(A) identifying an initial ratecard percentage associated with a seller;
(B) scaling the initial ratecard percentage up and down to produce a plurality of modified ratecard percentages;
(C) selecting, from among the plurality of modified ratecard percentages, a minimum ratecard percentage that satisfies at least one buyer constraint in connection with a plurality of inventory units; and
(D) selecting, from among the plurality of modified ratecard percentages, a maximum ratecard percentage that satisfies the at least one buyer constraint in connection with a plurality of inventory units having a plurality of associated rates.

12. The system of claim 11, wherein (B) comprises selecting a first initial scaling factor and scaling the initial ratecard percentage based on the first initial scaling factor.

13. The system of claim 12, wherein (B) further comprises selecting the first initial scaling factor to have a value greater than one, such that applying the first initial scaling factor to the initial ratecard percentage results in infeasibility of satisfying the at least one buyer constraint in connection with the plurality of inventory units.

14. The system of claim 13, wherein the at least one buyer constraint comprises a maximum spending constraint, and wherein (C) comprises:
(C) (1) scaling the plurality of associated rates based on the first initial scaling factor and the initial ratecard percentage to produce a plurality of scaled rates;
(C) (2) calculating a minimum deviation of the plurality of scaled rates from the maximum spending constraint; and
(C) (3) selecting the maximum ratecard percentage based on the calculated minimum deviation.

15. The system of claim 13, wherein (B) further comprises selecting a second initial scaling factor and scaling the initial ratecard percentage based on the second initial scaling factor.

16. The system of claim 15, wherein (B) further comprises selecting the second initial scaling factor to have a value less than one, such that applying the second initial scaling factor to the initial ratecard percentage results in infeasibility of satisfying the at least one buyer constraint in connection with the plurality of inventory units.

17. The system of claim 16, wherein the at least one buyer constraint comprises a maximum spending constraint, and wherein (D) comprises:
(D) (1) scaling the plurality of associated rates based on the first initial scaling factor and the initial ratecard percentage to produce a plurality of scaled rates;
(D) (2) calculating a minimum deviation of the plurality of scaled rates from the maximum spending constraint; and
(D) (3) selecting the minimum ratecard percentage based on the calculated minimum deviation.

18. The system of claim 11, wherein (C) comprises scaling rates associated with the plurality of inventory units based on the plurality of modified ratecard percentages to produce a plurality of modified rates, and selecting the minimum ratecard percentage based on the plurality of modified rates.

19. The system of claim 18, wherein (D) comprises scaling rates associated with the plurality of inventory units based on the plurality of modified ratecard percentages to produce a plurality of modified rates, and selecting the maximum ratecard percentage based on the plurality of modified rates.

20. The system of claim 11, wherein the at least one buyer constraint comprises a maximum spending constraint.
